(19) United States
(12) Patent Application Publication
(10) Pub. No.: US 2026/0155287 A1
(43) Pub. Date: Jun. 4, 2026

(54) ELECTROMAGNETIC ACTUATOR

(71) Applicant: Knorr-Bremse Systeme Fuer Nutzfahrzeuge GmbH, Munich (DE)

(72) Inventors: Friedbert Roether, Cleebronn (DE); Ralf Woerner, Tiefenbronn (DE); Benjamin Jensen, Grossbottwar (DE)

(21) Appl. No.: 18/715,462

(22) PCT Filed: Dec. 14, 2022
(86) PCT No.: PCT/EP2022/085870

§ 371 Date: May 31, 2024

(30) Foreign Application Priority Data
Dec. 15, 2021 (DE) 10 2021 133 226.5

(51) Int. Cl. H01F 7/08; F16K 31/06; H01F 7/14

(52) U.S. Cl. CPC H01F 7/081; F16K 31/0675; F16K 31/0682; H01F 7/14; H01F 2007/086

(57) ABSTRACT

An electromagnetic-actuator (EA) including a coil-assembly (CA) with a coil-core and a coil arranged about the coil-core circumference, a housing including a magnetic-material and a rotationally, symmetrical receiving-chamber in which the CA is at least partly received, and a movable-magnetic armature-body (MM AB), as a movable-actuator-element, is movable by a magnetic-field from the CA, the AB being supported relative to the housing on one-face by a bearing and is movable along a bearing-rotational-axis (BRA) from a first to second-position. The AB has a disc-like configuration and a symmetrical-shape with respect to an axis-of-symmetry (AOS) lying on the disc-plane and running transversely to the BRA, and the AB has a first longest-extension (LE) between opposite-ends of the AB in the direction of the AOS and a second LE between opposite-ends of the AB in the direction of the BRA, the second LE being shorter than the first LE.

### FIELD OF THE INVENTION

The present invention relates to an electromagnetic actuator with a coil assembly with at least one coil core and a coil arranged circumferentially around the coil core, a housing with a magnetic material and with a movable magnetic armature body as a movable actuator element which can be moved by a magnetic field generated by the coil assembly, wherein the armature body is mounted on one side by a bearing in relation to the housing and can be moved about a bearing axis of rotation from a first position into a second position.

### BACKGROUND INFORMATION

Such electromagnetic actuators are discussed, for example, in the form of electromagnetic switch or valve apparatuses such as, for example, in the form of an electromagnetic relay or solenoid valve. Solenoid valves, for example in the form of tilting armature valves, are used, for example, as control valves for regulating the pressure of air, for example in a vehicle, such as for example in a commercial vehicle or bus for transporting passengers. For example, a brake system for a vehicle with an electronic service brake system comprises at least one control valve for pressure regulation.

An electromagnetic actuator of the type mentioned at the beginning is understood, for example, from DE 10 2016 105 532 A1 in the form of a tilting armature valve. The electromagnetic actuator features a coil assembly and a movable magnetic armature body.

Further types of solenoid valves are understood, as discussed for example in DE 10 2014 115 207 A1, DE 10 2018 123 997 A1, or DE 10 2014 115 206 B3.

When a, for example, cylindrical housing which is part of the magnetic circuit is used, there is a risk that the armature body is positioned off-center because of tolerances.

This can cause a high transverse force which acts laterally on the armature body. A bearing point via which the armature body is mounted is thus additionally stressed and the magnetic force in the working direction is reduced which, on the one hand, can increase wear and, on the other hand, reduce efficiency.

### SUMMARY OF THE INVENTION

An object of the present invention is to specify an electromagnetic actuator of the type mentioned at the beginning which enables better durability and greater efficiency.

The invention relates to an electromagnetic actuator of the type mentioned at the beginning according to the attached claims. Advantageous embodiments and developments of the invention are specified in the subclaims and the following description.

In particular, one aspect of the present invention relates to an electromagnetic actuator with a coil assembly with at least one coil core and a coil arranged circumferentially around the coil core, a housing with a magnetic material and a rotationally symmetrical receptacle, in which the coil assembly is at least partially accommodated, and a movable magnetic armature body as a movable actuator element which can be moved by a magnetic field generated by the coil assembly. The armature body is mounted on one side by a bearing in relation to the housing and can be moved about a bearing axis of rotation from a first position into a second position. The armature body has a disk-like configuration and has a symmetrical shape with respect to an axis of symmetry, lying in a disk plane, transverse to the bearing axis of rotation. The armature body has a first largest extent between opposite ends of the armature body in the direction of the axis of symmetry and a second largest extent between opposite ends of the armature body in the direction of the bearing axis of rotation which is shorter than the first largest extent.

The electromagnetic actuator according to the invention enables the armature body to be movable securely and smoothly in the electromagnetic actuator because the configuration of the armature body allows a greater tolerance in a position of the armature body in the housing. In particular, on the one hand, more economic production methods can be used when producing the individual components and, on the other hand, the electromagnetic actuator, for example a solenoid valve for commercial vehicle applications, can be configured more robustly and reliably with respect to the wear of the armature bearing. Furthermore, a transverse force of the magnetic field acting through the air gap in an undesired direction can be reduced and the magnetic field in the desired functional direction amplified. Moreover, the electromagnetic actuator according to the invention enables greater robustness with respect to manufacturing tolerances without any negative influences on the magnetic force and production costs.

According to an embodiment of the electromagnetic actuator, the axis of symmetry is arranged perpendicularly to the bearing axis of rotation. This allows a uniform bearing force distribution of the armature body with respect to the bearing axis of rotation. This enables the stress on the bearing to be more uniform, as a result of which the electromagnetic actuator has improved durability.

According to an embodiment of the electromagnetic actuator, the first largest extent is a first diameter and the second largest extent a second diameter of the armature body. This shape enables an armature body which is configured in a defined manner and can be produced relatively simply for improved positioning and reducing transverse forces under tolerance conditions.

According to an embodiment of the electromagnetic actuator, the first largest extent is a largest diameter and the second largest extent a shortest diameter of the armature body. As a result, the armature body obtains an elongated, rounded, for example egg-shaped or elliptical, shape which improves an orientation of the armature body in the receptacle of the housing and of the magnetic field, acting on the armature body, in the armature body under tolerance conditions.

According to an embodiment of the electromagnetic actuator, the armature body has a convex, in particular oval, outer contour in the disk plane. Such an outer contour makes it possible, even in the case of an oblique position of the armature body transverse to the bearing axis of rotation, for the air gap between the housing and an outer side to be sufficient at the circumference of the armature body. By virtue of such a geometrical shape of the armature body, the magnetic flux can be directed in an amplified manner in a particular direction such that it is amplified at the longest lever arm and the magnetic force acting on the armature body is thus increased with a reduction in transverse forces.

According to an embodiment of the electromagnetic actuator, the armature body has, in the direction of the axis of symmetry, two first regions situated opposite each other with a respective round outer contour and, in the direction of the bearing axis of rotation, two second regions situated opposite each other with a respective outer contour which is flattened compared with the first regions. This also enables improved positioning of the armature body and a reduction in transverse forces under tolerance conditions.

According to an embodiment of the electromagnetic actuator, the two first regions situated opposite each other have a respective circular outer contour. The two first regions situated opposite each other thus enable a largely constant air gap between the armature body and the housing close to the bearing or the opposite end of the armature body.

According to an embodiment of the electromagnetic actuator, the respective flattened outer contour has a barrel-shaped configuration. A barrel-shaped structure or arrangement means in particular that the contour is flattened compared with an arc of a circle and in particular can have different radii, wherein a middle part of the flattened outer contour has a larger radius than at end parts, adjoining the middle part, of the flattened outer contour. The end parts of the flattened outer contour connect the flattened outer contour, for example, to a respective circular outer contour.

According to an embodiment of the electromagnetic actuator, the receptacle of the housing has a cylindrical configuration. This enables, together with the armature body, good positioning under tolerance conditions and simplified production.

According to an embodiment of the electromagnetic actuator, in the case of a symmetrical orientation of the armature body with respect to the receptacle of the housing in the disk plane, an air gap in the direction of the axis of symmetry between the armature body at a position of the first largest extent and a closest part of the housing is smaller than an air gap in the direction of the bearing axis of rotation between the armature body at a position of the second largest extent and a closest part of the housing. The magnetic flux is positively directed by the air gap of differing width such that the magnetic flux at the longest lever arm is amplified and the magnetic force at the armature body thus increases.

According to an embodiment of the electromagnetic actuator, the coil core has a rotationally symmetrical region, with an axis of symmetry, in which the coil core is surrounded circumferentially by the coil, wherein the bearing is arranged radially offset with respect to the axis of symmetry of the coil core and the armature body extends radially beyond the coil core. This enables precise movement of the armature body mounted on one side because the latter can largely, in particular completely, move within the magnetic field generated. The positioning of the bearing enables an advantageous one-sided mounting of the armature body. In this way, a robust and reliable electromagnetic actuator can be created under tolerance conditions and reduced transverse forces.

According to an embodiment of the electromagnetic actuator, the electromagnetic actuator takes the form of an electromagnetic switch or valve apparatus with the armature body as a switch or valve element, in particular an electromechanical relay or solenoid valve.

According to an embodiment of the electromagnetic actuator, the electromagnetic actuator takes the form of a tilting armature valve.

According to an embodiment of the electromagnetic actuator, the electromagnetic actuator takes the form of a solenoid valve for a pressure regulation module of a vehicle.

The embodiments described herein can be applied alongside one another or also in any desired combination with one another.

The invention is explained in detail below on the basis of the figures illustrated in the drawings.

### BRIEF DESCRIPTION OF THE DRAWINGS

FIG. 1A shows a schematic illustration in cross-section of an exemplary tilting armature valve in which an electromagnetic actuator according to the invention can in principle applied.

FIG. 1B shows a schematic illustration in cross-section of an exemplary tilting armature valve in which an electromagnetic actuator according to the invention can in principle applied.

FIG. 2 shows a perspective illustration of an exemplary known armature body for use in an exemplary tilting armature valve according to FIG. 1.

FIG. 3 shows a schematic illustration in cross-section of an armature body in a housing of an embodiment of an electromagnetic actuator according to the invention along the disk plane of the armature body in a position oriented in the housing.

FIG. 4 shows a schematic illustration in cross-section of the armature body in the housing of an embodiment of an electromagnetic actuator according to the invention along the disk plane of the armature body, wherein the armature body is illustrated in a pivoted position under tolerance conditions.

### DETAILED DESCRIPTION

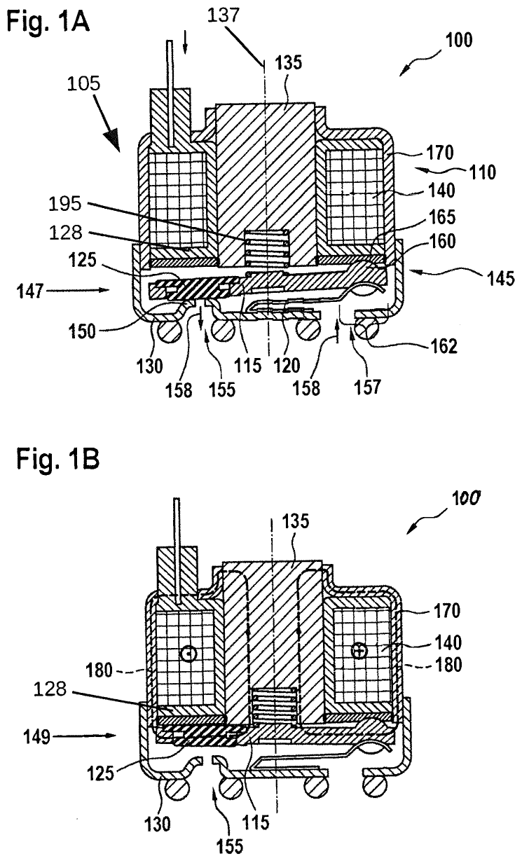

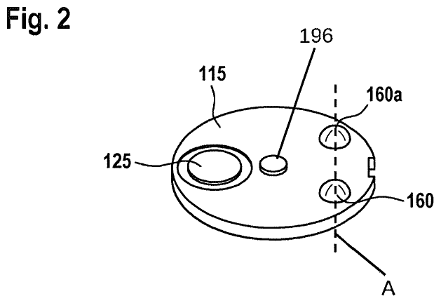

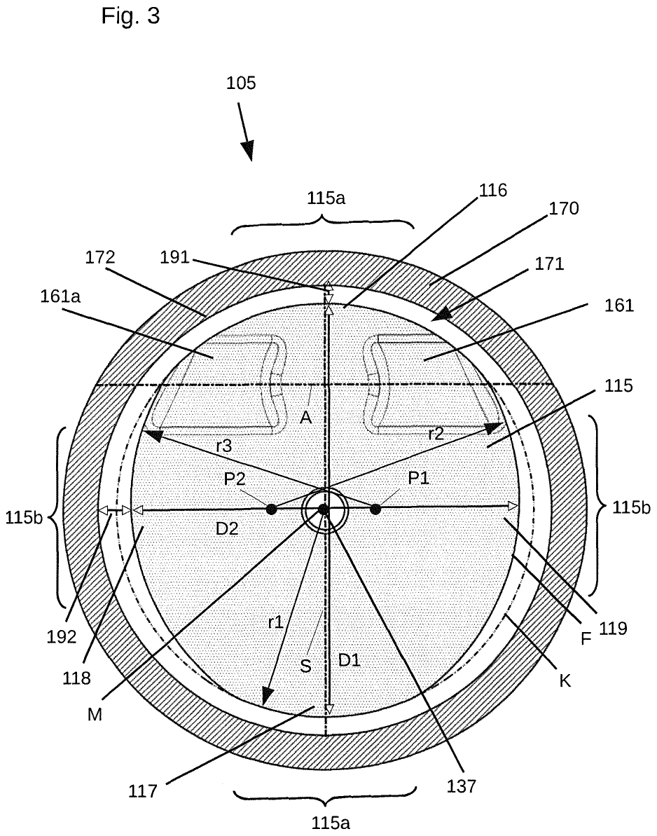

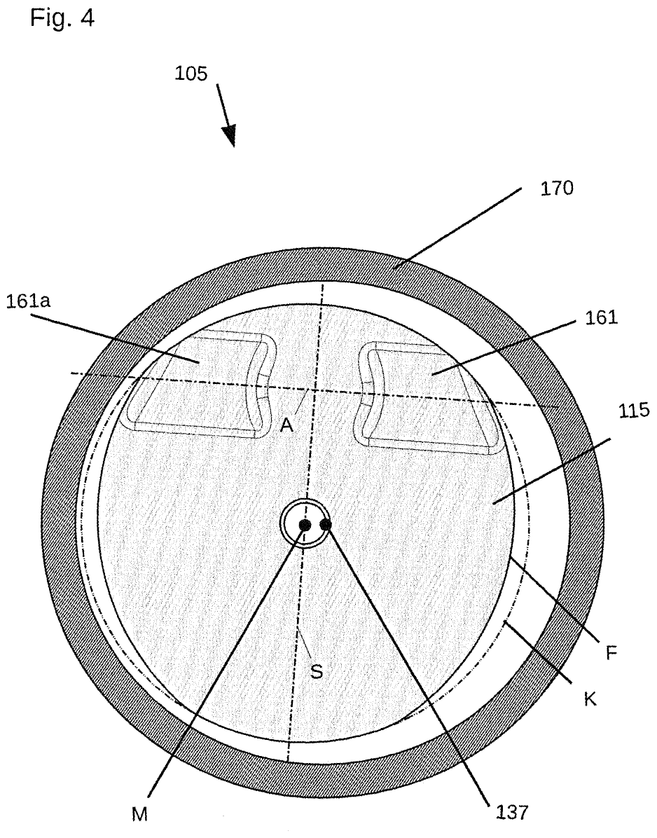

FIG. 1 shows with the aid of FIG. 1A and FIG. 1B a simplified illustration in cross-section of a tilting armature valve 100 in which an electromagnetic actuator 105 according to the invention with an armature body 115, as illustrated in FIGS. 3 and 4, can in principle be applied. FIG. 1 is intended here to illustrate the exemplary use in practice of an electromagnetic actuator on the basis of a tilting armature valve. FIG. 2 shows in contrast an exemplary armature body 115 which is known from DE 10 2016 105 532 A1. The configuration according to the invention of the armature body 115 can be illustrated more understandably on the basis of FIG. 2. A configuration according to the invention of an armature body 115 is illustrated in detail here in FIGS. 3 and 4 according to an exemplary embodiment and can in principle be readily transferred by a person skilled in the art to a tilting armature valve according to FIG. 1. In this connection, it should be pointed out that the fundamental operating principle of electromagnetic apparatuses such as switch or valve apparatuses with an armature body which can be moved by a magnetic field as a switch or valve element is known to a person skilled in the art.

The same, mutually corresponding components or those with the same action are designated in FIGS. 1-4 with the same reference signs.

The tilting armature valve 100 can, according to the basic principle, be an exemplary embodiment of a tilting armature valve 100 shown in DE 10 2016 105 532 A1. In a variant, it can here be a solenoid valve provided in FIG. 1 there with the reference sign 100. Other exemplary embodiments are, however, also conceivable, for example in connection with solenoid valves as described in the other abovementioned documents. Relevant embodiments of a solenoid valve described in DE 10 2016 105 532 A1 and their components and their use are by reference also part of the disclosure of the present invention.

FIG. 1A shows an illustration of a cross-section through a tilting armature valve 100, in which the armature body is situated in the first position. The tilting armature valve 100 has a coil element 110, an armature body (or armature for short) 115, a spring 120, a sealing element 125, and a cover cap 130. The coil element 110, which is configured rotationally symmetrically with its main components the coil, coil core, and coil body, here comprises at least one cylindrical coil core 135 which has an axis of symmetry 137, a coil body 128 arranged circumferentially around the coil core 135, and a coil 140, arranged circumferentially around the coil body 128, with a stack of coil windings (not illustrated explicitly). An end side of the armature 115 is mounted in relation to the housing 170 by a bearing 145. The armature body 115 can move between a first position 147 and a second position 149. The armature body 115 is here configured to be moved from the first position 147 into a second (drawn-in) position 149 when the coil 140 is activated. When the coil 140 is activated, the armature body 115 can be held in the second position 149. On that side of the armature 115 which faces away from the coil element 110, the sealing element 125 is furthermore arranged. Formed in the cover cap 130 is a valve seat 150 with an output 155 and an input 157 for a fluid 158. The output 155 can here be closed fluidtightly by the sealing element 125 when the armature body 115 is arranged in the first position 147. The sealing element 125 can here moreover also act as a damping element in order to prevent the armature 115 striking the valve seat 150. The sealing element 125 can here be fastened by vulcanization on the armature body 115 or a support element. It is moreover conceivable that an angle is produced when the armature 115 or sealing element 125 hits the valve seat 150 by an oblique nozzle or an obliquely shaped sealing element 125 or a curved armature body 115. Such a nozzle, which is not illustrated explicitly in FIG. 1A, does not necessarily need to be integrated into the tilting armature valve 100 and instead can also be supplied by external housing parts.

It is moreover conceivable that the valve seat 150 is arranged in the coil element 110 but this is not illustrated explicitly in FIG. 1A for reasons of visibility. In this case, an actuator would then be advantageous which enables the output to be unblocked by the armature body 115.

In this exemplary embodiment, the armature body 115 has at least one at least partially round raised section 160 in a bearing portion 162, wherein the raised section 160 engages in a recess 165 or opening which is arranged, for example, in a portion, situated opposite the raised section 160, of the housing 170 or the coil body 128 of the tilting armature valve 100. As a result, the armature body 115 can slide in the recess in the case of movement from the first position 147 into the second position 149 after a flow of current through the coil 140 has been switched on and at the same time is held at a stationary position in the housing 170 or with respect to the cover cap 130. The recess is configured as trapezoidal such that as little friction as possible is caused when the raised section slides over the surface of the recess 165. The recess 165 can be manufactured, for example, from plastic material.

In this example, the spring 120 takes the form of a leaf spring and is arranged in the bearing portion on a side, situated opposite the coil 140, of the armature 115. The spring 120 here serves to push, with no play, the ball bearing(s) which are for example press-fitted into the armature body 115, into the (for example trapezoidal) mating shell or recess 165 in the housing 170 of the coil element 110. The armature body 115 can be fixed by the spring 120 such that the armature body 115 is held in a predetermined position by the spring 120. This affords the advantage that a constant pretensioning force can be exerted on the armature body 115 and the force exerted on the armature body 115 by the spring 120 can be imparted to the armature body 115 as closely as possible to a force application point situated on the bearing axis of rotation.

Alternatively, the armature body 115 can also be suspended from the coil element 110. In this case, the spring 120, which takes the form for example of a leaf spring, could then be omitted.

FIG. 1B shows an illustration in cross-section through a tilting armature valve 100, in which the armature body 115 is situated in the second position 149. In this case, a current through the coil 140 is switched on and the armature body 115 drawn in such that a magnetic field illustrated by the field lines 180 is established. When the current through the coil 140 is switched off, the armature body 115 can fall back into the first position 147, for example by virtue of gravity or a spring force of an illustrated return spring 195.

FIG. 2 shows a perspective illustration of an exemplary known armature body 115 for use in the tilting armature valve 100. The armature body 115 here takes the form of a plate armature. The armature body 115 has, in addition to the sealing element 125, two press-fitted balls as raised sections 160, 160a which are arranged in a direction which forms a bearing axis of rotation A of the armature body 115 during the rotation after the current through the coil 140 has been switched on. This means that the raised sections 160 and 160a are arranged on or along the bearing axis of rotation A. The raised sections 160, 160a form a part of a bearing assembly in order to arrange the armature body 115 on an end side of the coil element 110. Formed centrally on the armature body 115 is a spring fastening portion 196 which interacts with the return spring 195 and prevents the return spring 195 from slipping off the armature body 115. The armature body 115 can be pretensioned into the first position via the spring fastening portion 196 by the return spring 195 in order to close the valve when current is not applied to the coil 140.

FIG. 3 shows a schematic illustration in cross-section of an armature body 115 in a housing 170 along the disk plane of the armature body according to an embodiment of an electromagnetic actuator 105 according to the invention. The armature body 115 in FIG. 3 is arranged in a rotationally symmetrical, in particular cylindrical, receptacle 171 of the likewise cylindrical housing 170 such that a circumferential air gap is formed between a circumference of the armature body 115 and an inner side 172 of the housing 170. The armature body 115 is configured in the manner of a disk or plate and has a symmetrical (here in particular axially symmetrical) shape with reference to an axis of symmetry S situated in the disk plane. In the manner of a disk or plate means in particular that the armature body 115 has a thickness (in the direction perpendicular to the disk plane) which is less than an extent in the disk plane of the armature body 115. The armature body 115 is, as described by way of example on the basis of FIG. 1, mounted on one side in relation to the housing 170 by a bearing 145 and can be moved along a bearing axis of rotation A between the first position 147 and the second position 149. The bearing 145 is arranged by way of example close to one end, in particular a first end 116, of the armature body 115. The bearing axis of rotation A is oriented transversely, in particular perpendicularly, to the axis of symmetry S and, like the axis of symmetry S, parallel to the disk plane. The bearing is formed by way of example by two bearing portions 161 and 161a arranged and spaced apart along the bearing axis of rotation A (for example in the form of depressions in the armature body which are indicated in FIG. 3) and which allow rotation of the armature body 115 about the bearing axis of rotation A. The bearing portions 161 and 161a can be formed in different ways, for example as depressions or as raised sections, as illustrated for example in FIG. 2 on the basis of the raised sections 160, 160a. A large number of types of bearing can be used.

The bearing portions 161 and 161a are arranged in a radially outer region of the armature body 115 relative to a central point M, here a point of intersection of a central axis in the normal direction of the armature body 115 with the disk plane. This means that the bearing axis of rotation A is likewise arranged in a radially outer region of the armature body 115. In the installed state of the armature body 115, the central point M is arranged approximately aligned with the axis of symmetry 137 of the coil core 135. In the installed state, the armature body 115 extends radially beyond the coil core 135 relative to the axis of symmetry 137.

The armature body 115 is mounted on one side in relation to the housing 170 such that the majority of the armature body 115 forms a lever arm at which a magnetic force, generated by a magnetic field of the coil assembly, can be applied in order to move the armature body 115 into the second position 149. The lever arm extends essentially from the bearing axis of rotation A to a second end 117, situated remote from the bearing axis of rotation A, of the armature body 115. One-sided bearing of the armature body means that the bearing may be arranged at one frontal end or in a region between a frontal end and a central point of the armature body.

The armature body 115 has a first largest extent D1 in the direction of the axis of symmetry S, here between the first end 116 and the second end 117. The largest extent D1 corresponds in particular to the largest diameter of the armature body 115. The armature body 115 moreover has a second largest extent D2 between a third end 118 and a fourth end 119 in the direction of the bearing axis of rotation A. The second largest extent D2 is shorter than the first largest extent D1. The second largest extent D2 corresponds in particular to the smallest diameter of the armature body 115.

In the armature body 115, the first largest extent D1 has a first, in particular largest diameter and the second largest extent D2 has a second, in particular smallest diameter. This means that the armature body 115 has a convex, in particular oval outer contour. In particular, the armature body 115 in this embodiment has a plane, round, convex outer contour in the disk plane. The armature body 115 has two first regions 115a, situated opposite each other, with a respective round (for example, circular) outer contour K in the direction of the axis of symmetry S. The first end 116 and the second end 117 of the armature body 115 lie in the corresponding regions 115a. The armature body 115 has two second regions 115b, situated opposite each other, in the direction of the bearing axis of rotation A. The second regions 115b situated opposite each other have an outer contour F which is flatter or flattened compared with the first regions 115a.

The outer contour K which is circular here has, for example, a radius r1, starting from the central axis of the armature body 115, which is somewhat smaller than an internal radius of the housing receptacle 171 such that an air gap 191 remains between the first regions 115a and the inner side of the housing receptacle 171.

The outer contour F which is barrel-shaped here has a larger radius r2 or r3 than the radius r1. A measurement point P1 for the radius r2 lies between the central axis and the right-hand second region 115b with reference to FIG. 3. A measurement point P2 for the radius r3 lies between the central axis and the opposite second region 115b with reference to FIG. 3.

A contour which is configured as barrel-shaped includes, within the sense of this disclosure, that at least one contour or part contour is present which has a rounded or bulged, in particular outwardly bulged (convex) shape, in particular a shape which deviates from the shape of an arc of a circle. The bulged or rounded aspect, in particular deviating from the shape of an arc of a circle and narrowing the disk shape, is more important here than for example a precise barrel shape in the mathematical sense being formed but it can also have specific advantages in terms of the positioning under tolerance conditions. For example, elliptical, egg-shaped, or other rounded or curved contours are thus also to be implied by this term. Contours which are straight in parts or in some places can also be provided in contour regions which are situated between rounded contour regions.

Because the outer contour F is configured as flatter compared with the outer contour K, in the case of a symmetrical orientation of the armature body 115 with reference to the receptacle 171 of the housing 170 in the disk plane, an air gap 191 in the direction of the axis of symmetry S between the armature body 115 at a position of the first largest extent D1 and a closest part of the housing 170 is smaller than an air gap 192 in the direction of the bearing axis of rotation A between the armature body 115 at a position of the second largest extent D2 and a closest part of the housing 170.

In FIG. 4, the armature body 115 is shown a deflected position, in particular in a position pivoted under tolerance conditions, for example in the second drawn-in position 149 of FIG. 1, for example under the influence of magnetic force. FIG. 4 shows an exemplary position of the armature body 115, for example when a magnetic field is generated by the coil assembly. During the production of the actuator and/or as a consequence of tolerances at the dimensions of the components, it can occur that the armature body 115 is positioned off-center because of the tolerances, for example tolerances at the bearing 145, tolerances at the configuration of the armature body 115, and/or also tolerances at the housing 170. This can cause relatively high transverse forces to occur which act on the armature body 115 in the direction of the bearing axis of rotation A and thus additionally stress the bearing 145 and reduce the magnetic force in the working direction. Because of the configuration according to the invention of the armature body 115, a reduced, minimal air gap 191 in the direction of the axis of symmetry S is formed even when the armature body 115 pivots in the direction of the bearing axis of rotation and moves off-center in the direction of a part of the housing 170, in FIG. 4 for example a left-hand part of the housing 170. However, the magnetic flux continues to be directed positively in the working direction, in particular in the direction of the longest lever arm, through the air gap, which as before is relatively small, on both sides of the armature body 115 in the direction of the axis of symmetry S.

In FIG. 4, the armature body 115 is both offset radially with respect to the axis of symmetry 137 and twisted in the housing 170. It is hereby illustrated that the armature body 115 can not only be displaced linearly by the magnetic field but also be twisted by it about the axis of symmetry 137 of the coil core 135. This means that the bearing portions 161 and 161a are stressed not only along the bearing axis of rotation A but also partially along the axis of symmetry S.

The air gap between the armature and the housing can be reduced in particular depending on possible wear of the bearing and component tolerances on both sides (in the direction of the axis of symmetry S). For example, a tolerance-dependent axis of rotation (axis of symmetry) perpendicular to the bearing axis of rotation is defined depending on the production method. The armature body can in theory be rotated to a maximum tolerance about this axis and the outer contour of the armature generated by a defined minimum air gap. A round disk shape with barrel-shaped flattened parts at the sides relative to the original diameter thus results. Greater robustness with respect to wear and manufacturing tolerances is thus obtained, largely without any negative influences on the magnetic force and production costs.

### THE LIST OF REFERENCE SIGNS IS A FOLLOWS

100 tilting armature valve

105 electromagnetic actuator

110 coil element

115 armature body

115a first regions

115b second regions

116 first end

117 second end

118 third end

119 fourth end

120 spring

125 sealing element

128 coil body

130 cover cap

135 coil core

137 axis of symmetry

140 coil

145 bearing

147 first position

149 second position

150 valve seat

155 output

157 input

158 fluid

160, 160a raised section

161, 161a bearing portion

162 bearing portion

165 recess

170 housing

171 receptacle

172 inner side

180 magnetic field

191 air gap

192 air gap

195 return spring

196 spring fastening portion

A bearing axis of rotation

D1 extent/diameter

D2 extent/diameter

F flattened outer contour

K circular outer contour

S axis of symmetry

M central point

P1 measurement point

P2 measurement point

r1 radius

r2 radius

r3 radius

1-14. (canceled)

15. An electromagnetic actuator, comprising:
a coil assembly with at least one coil core and a coil arranged circumferentially around the coil core;
a housing with a magnetic material and a rotationally symmetrical receptacle, in which the coil assembly is at least partially accommodated; and
a movable magnetic armature body, which is configured as a movable actuator element and which can be moved by a magnetic field generated by the coil assembly, wherein the armature body is mounted on one side by a bearing in relation to the housing and is movable about a bearing axis of rotation from a first position into a second position;
wherein the armature body has a disk-like configuration and has a symmetrical shape with respect to an axis of symmetry, lying in a disk plane, transverse to the bearing axis of rotation, wherein the armature body has a first largest extent between opposite ends of the armature body in a direction of the axis of symmetry and a second largest extent between opposite ends of the armature body in a direction of the bearing axis of rotation which is shorter than the first largest extent.

16. The electromagnetic actuator of claim 15, wherein the axis of symmetry is arranged perpendicularly to the bearing axis of rotation.

17. The electromagnetic actuator of claim 15, wherein the first largest extent is a first diameter and the second largest extent a second diameter of the armature body.

18. The electromagnetic actuator of claim 15, wherein the first largest extent is a largest diameter and the second largest extent a shortest diameter of the armature body.

19. The electromagnetic actuator of claim 15, wherein the armature body has a convex or oval, outer contour in the disk plane.

20. The electromagnetic actuator of claim 15, wherein the armature body has, in the direction of the axis of symmetry, two first regions situated opposite each other with a respective round outer contour and, in the direction of the bearing axis, two second regions situated opposite each other with a respective outer contour which is flattened compared with the first regions.

21. The electromagnetic actuator of claim 20, wherein the two first regions situated opposite each other have a respective circular outer contour.

22. The electromagnetic actuator of claim 20, wherein the respective flattened outer contour has a barrel-shaped configuration.

23. The electromagnetic actuator of claim 15, wherein the receptacle of the housing has a cylindrical configuration.

24. The electromagnetic actuator of claim 15, wherein, in the case of a symmetrical orientation of the armature body with respect to the receptacle of the housing in the disk plane, an air gap in the direction of the axis of symmetry between the armature body at a position of the first largest extent and a closest part of the housing is smaller than an air gap in the direction of the bearing axis of rotation between the armature body at a position of the second largest extent and a closest part of the housing.

25. The electromagnetic actuator of claim 15, wherein the coil core has a rotationally symmetrical region, with an axis of symmetry, in which the coil core is surrounded circumferentially by the coil, and the bearing is arranged radially offset with respect to the axis of symmetry of the coil core and the armature body extends radially beyond the coil core.

26. The electromagnetic actuator of claim 15, wherein the electromagnetic actuator takes the form of an electromagnetic switch or valve apparatus with the armature body as a switch or valve element, which is an electromechanical relay or a solenoid valve.

27. The electromagnetic actuator of claim 15, wherein the electromagnetic actuator takes the form of a tilting armature valve.

28. The electromagnetic actuator of claim 15, wherein the electromagnetic actuator takes the form of a solenoid valve for a pressure regulation module of a vehicle.
